(19) United States
(12) Patent Application Publication
(10) Pub. No.: US 2026/0334430 A1
(43) Pub. Date: Oct. 29, 2026

(54) FEEDING SYSTEM AND METHOD FOR FEEDING ANIMALS, AND IN COMBINATION, A SHED FOR KEEPING ANIMALS AND SUCH A FEEDING SYSTEM

(71) Applicant: LELY PATENT N.V., Maassluis (NL)

(72) Inventor: Tom Adrianus Josephus VAN DE VEN, Maassluis (NL)

(73) Assignee: LELY PATENT N.V., Maassluis (NL)

(21) Appl. No.: 19/115,352

(22) PCT Filed: Oct. 5, 2023
(86) PCT No.: PCT/IB2023/060012

§ 371 Date: Mar. 26, 2025

(30) Foreign Application Priority Data
Oct. 12, 2022 (NL) 2033295

(51) Int. Cl. A01K 5/00; A01K 5/02

(52) U.S. Cl. CPC A01K 5/001; A01K 5/0266

(57) ABSTRACT

A feeding system for feeding animals, in particular cattle, comprises an autonomous feeding device with a holder for receiving a batch of feed. The holder has a maximum feed load. A feed quantity measuring device measures the quantity of feed which is available for consumption by the animals at feeding places. A control system determines at a first moment a feed requirement of the feeding places on the basis of a feeding criterion and the measured quantity of feed at the feeding places. The control system selects a first feeding place with a feed requirement. Then the control system determines a required feed quantity which is equal to a first feed quantity determined for the first feeding place, and one or more further feed quantities determined for one or more further feeding places selected by the control system from the feeding places with a feed requirement, if said further feed quantities can be added to the first feed quantity without exceeding the maximum feed load. If the required feed quantity is smaller than a threshold value for a minimum feed load, the control system adds to the required feed quantity one or more additional feed quantities which are intended for one or more additional feeding places selected by the control system from the feeding places which do not yet have a feed requirement at the first moment. The control system determines the additional feeding places such that the feed quantity to be loaded is equal to or greater than the threshold value for the minimum feed load.

The invention concerns a feeding system for feeding animals, in particular cattle, such as dairy cows or beef cattle.

WO 2013/112042 A1 describes a feeding system for feeding animals. Said feeding system comprises an autonomous feeding device with a holder for receiving a batch of feed. The holder has a maximum feed load, i.e. the maximum weight of feed (kg) which can be received in the holder. The feeding device is configured to move autonomously towards feed fences in order to bring the feed received in the holder to the feed fences and dispense it there. The feeding device comprises a control system with a feed height meter. While the feeding device is travelling along a feed fence, the feeding device pushes the feed lying on the floor into a swathe-shaped heap of feed along the feed fence, and the feed height meter measures the height of the top of the feed heap. From the feed height signal, the control system determines the quantity of feed still available for consumption by the animals at the feeding places. The quantity of feed is therefore measured by means of the feed height signal. On the basis of the measured feed quantities at the different feed fences, the control system determines at which of said feed fences feed should be dispensed. In other words, the autonomous feeding device provides feed not according to a fixed timetable but in a demand-led fashion.

Demand-led feeding has significant advantages. For feeding, the farmer seeks a compromise between firstly guaranteeing that the animals can always eat, and secondly maintaining the feed quality, in particular its freshness. In dairy cows, it is important for the milk production and health of the dairy cows that feed is always available at the feeding places. Also in other animals, such as beef cattle, it is important that the animals can always eat. But if a large quantity of feed is dispensed at one time at the feeding places, and the feed remains there for some time, the quality of the feed diminishes, for example due to rotting. With demand-led feeding, it is possible to deposit relatively little feed at the feeding places, so that the quality of the feed remains guaranteed, and at the same time add feed in good time to prevent the animals running out of feed.

Sometimes however, the control system determines that only a small quantity of feed need be dispensed at one or more feeding places. The autonomous feeding device then travels to the feeding place or places concerned with only a small batch of feed. When the autonomous feeding device carries only a small batch of feed, the capacity of the holder is not optimally used. This has a negative effect on the capacity of the demand-led feeding system during the day.

It is an object of the invention to provide an improved demand-led feeding system with an autonomous feeding device for feeding animals, wherein in particular the capacity of the feeding system during the day is increased.

This object is achieved according to the invention by a feeding system for feeding animals, in particular cattle, such as dairy cows or beef cattle, at multiple feeding places with feed from a feed supply, wherein the feeding system comprises:
at least one feeding device with a holder for receiving a batch of feed, which holder has a maximum feed load, and which feeding device is configured to move autonomously to the feeding places in order to bring feed received in the holder to the feeding places and dispense it there,
a feed loading system for loading feed from the feed supply into the holder of the feeding device,
a feed quantity measuring device for repeated measurement of the quantity of feed available for consumption by the animals at the feeding places, and
a control system, which is configured to:
   at a first moment, determine a feed requirement for the feeding places on the basis of a feeding criterion and the feed quantity measured by the feed quantity measuring device at the feeding places,
   select a first feeding place from the feeding places with a feed requirement, in particular a feed requirement greater than 0,
   calculate the quantity of feed to be loaded which is equal to a sum of
      a required feed quantity which is equal to
         a first feed quantity which is determined for the first feeding place, and
         one or more further feed quantities which are determined for one or more further feeding places selected by the control system from the feeding places with a feed requirement, if said one or more further feed quantities can be added to, i.e. totaled with, the first feed quantity without exceeding the maximum feed load of the holder of the autonomous feeding device,
   wherein the control system is configured to compare the required feed quantity with a threshold value for a minimum feed load, and
      if the control system, on the basis of said comparison of the required feed quantity with the threshold value for the minimum feed load, determines that the required feed quantity is smaller than the threshold value for the minimum feed load, one or more additional feed quantities which are determined for one or more additional feeding places selected by the control system from the feeding places which do not yet have a feed requirement at the first moment, but which will have a feed requirement after the first moment, wherein the control system determines the one or more additional feeding places such that the quantity of feed to be loaded is equal to or greater than the threshold value for the minimum feed load,
   control the feed loading system to load the calculated quantity of feed to be loaded from the feed supply into the holder of the feeding device, and
   control the feeding device to bring the loaded quantity of feed to the one or more selected feeding places, i.e. the first feeding place, where applicable the one or more further feeding places with a feed requirement, and in some cases the one or more additional feeding places which do not yet have a feed requirement at the first moment, and dispense it there.

The feeding system according to the invention works on the demand-led principle. The feed quantity measuring device repeatedly measures the quantity of feed available for consumption by the animals at the feeding places. The control system determines, on the basis of a feeding criterion and the measured quantity of feed at the feeding places, a feed requirement for each of the feeding places. The control system for example generates a list of feeding places with a feed requirement. The feeding places which have a feed requirement at the first moment are considered for additional feed.

The control system then calculates in the following manner the quantity of feed to load into the holder of the autonomous feeding device. The control system selects a first feeding place from the list of feeding places with a feed requirement. The control system determines a first feed quantity to dispense at the first feeding place. Then the control system determines which further feed quantities are required at the further feeding places from the list of feeding places with a feed requirement. The control system analyses whether one or more of the further feed quantities can be added to the first feed quantity without exceeding the maximum feed load of the holder. The maximum feed load is in particular a maximum weight of feed (kg) which can be received in the holder. The control system adds as many further feed quantities as possible to the first feed quantity. The required feed quantity calculated by the control system is equal to the sum of the first feed quantity and said one or more further feed quantities. If no single further feed quantity from the list of feeding places with a feed requirement fits into the holder with the first feed quantity, the required feed quantity is equal to the first feed quantity.

The control system then compares the required feed quantity with a threshold value for a minimum feed load, in particular a minimum weight of feed (kg) to be received in the holder. In practice, it occurs that the required feed quantity—i.e. even after all possible further feed quantities for the further feeding places from the list of feeding places with a feed requirement have been added to the first quantity—may still be undesirably small, whereby the capacity of the autonomous feeding device would be insufficiently used. If the comparison of the required feed quantity with the minimum feed load shows that the required feed quantity is smaller than the threshold value for the minimum feed load, the control system increases the quantity of feed to be loaded. For this, the control system selects one or more additional feeding places which at the first moment did not yet have a feed requirement, and adds one or more additional feed quantities which are intended for said one or more additional feeding places. The control system determines the one or more additional feeding places such that the quantity of feed to be loaded, i.e. with the one or more additional feed quantities added to the required feed quantity, is equal to or greater than the threshold value for the minimum feed load.

Then the control system controls the feed loading system to load the calculated feed quantity to be loaded from the feed supply into the holder of the autonomous feeding device. The autonomous feeding device then brings the loaded feed quantity to the one or more selected feeding places, i.e. to the first feeding place, where applicable to the one or more further feeding places with a feed requirement, and in some cases to the one or more additional feeding places which at the first moment did not yet have a feed requirement.

Thus the feeding system according to the invention has the advantages of demand-led feeding, i.e. it is guaranteed that the animals always have sufficient feed at their disposal, wherein the quality of the feed, in particular the freshness, is retained as well as possible while furthermore preventing the demand-controlled autonomous feeding device from transporting small batches of feed, so that the capacity of the holder is better used and the capacity of the demand-led feeding system according to the invention is greater during the day.

It is noted that WO 2013/095281 A1 discloses a feeding system for feeding animals with mixed feed according to different recipes. Said feeding system comprises a feed mixing device for mixing batches of feed according to selected recipes, and a feed distribution system for distributing the batches of mixed feed over various groups of animals. If a group consists of only a few animals, for example sick animals, only a small batch of feed need be mixed compared with the maximum load capacity of the feed mixer. The feed mixer then does not chop and mix well. Also the accuracy is insufficient when loading small quantities of ingredients, so that the feed composition is not optimal. If only a small batch according to a first recipe is required, the feed mixer in said feeding system is therefore nonetheless loaded with a large batch according to the first recipe. The required small batch is dispensed to the animals and the remaining quantity of mixed feed according to the first recipe is then used to make a following batch of mixed feed according to a second recipe and fed to another group of animals. In other words, ingredients are added to the remaining quantity of mixed feed in order to obtain a batch of mixed feed according to the second recipe. Said feeding system is complicated and has no connection with demand-led feeding.

In an embodiment according to the invention, the control system is configured to determine, for the feeding places which at the first moment had no feed requirement on the basis of the feeding criterion, a second feed requirement on the basis of a second, in particular less stringent feeding criterion and the feed quantity measured by the feed quantity measuring device for the feeding places, and wherein the control system is configured to select the one or more additional feeding places on the basis of said second feed requirement. One or more feeding places which did not yet have a feed requirement on the basis of the (first) feeding criterion may in fact have a second, in particular less urgent feed requirement on the basis of the second less stringent feeding criterion, i.e. the feeding places can be filled up, but this is not required as quickly. In particular, the control system is configured to select said feeding place or said feeding places as one or more additional feeding places which have the highest priority on the basis of the second feed requirement. In other words, the feeding places which do not yet have a requirement on the basis of the feeding criterion but are closest to this are selected by the control system as the additional feeding places.

The feeding system according to the invention is preferably configured for feeding animals with mixed feed. In a preferred embodiment according to the invention, the control system comprises a memory in which different recipes for mixed feed are stored, wherein each recipe contains one or more ingredients in a predetermined ratio, and wherein the control system is configured, for at least each feeding place with a feed requirement, to determine the associated recipe for mixed feed, wherein the recipe belonging to the first feeding place is a first recipe, and wherein the quantity of feed to be loaded, in particular containing different ingredients according to the first recipe, is equal a sum of
a required feed quantity according to the first recipe which is equal to
   a first feed quantity according to the first recipe which is determined for the first feeding place, and
   one or more further feed quantities according to the same first recipe which are determined for one or more further feeding places selected by the control system from the feeding places with a feed requirement for mixed feed according to said first recipe, if said one or more further feed quantities according to the first recipe can be added to, i.e. totaled with, the first feed quantity according to the first recipe without exceeding the maximum feed load of the holder of the autonomous feeding device, and
wherein the control system is configured to compare the required feed quantity with a threshold value for a minimum feed load, and
if the control system, on the basis of said comparison of the required feed quantity according to the first recipe with the threshold value for the minimum feed load, determines that said required feed quantity according to the first recipe is smaller than the threshold value for the minimum feed load, one or more additional quantities of feed according to the same first recipe which are determined for one or more additional feeding places selected by the control system from the feeding places which do not yet have a feed requirement for mixed feed according to said first recipe at the first moment, but after the first moment will have a feed requirement for mixed feed according to said first recipe, wherein the control system determines the one or more additional feeding places such that the quantity of feed to be loaded is equal to or greater than the threshold value for the minimum feed load.

This preferred embodiment can also be described as a feeding system for feeding animals, in particular cattle, such as dairy cows or beef cattle, at multiple feeding places with feed from a feed supply, wherein the feeding system comprises:
at least one feeding device with a holder for receiving a batch of mixed feed, which holder has a maximum feed load, and which feeding device is configured to move autonomously to the feeding places in order to bring mixed feed received in the holder to the feeding places and dispense it there,
a feed loading system for loading feed, in particular comprising different ingredients, from the feed supply into the holder of the feeding device,
a feed quantity measuring device for repeated measurement of the quantity of feed available for consumption by the animals at the feeding places, and
a control system with a memory in which different recipes for mixed feed are stored, wherein each recipe contains one or more ingredients in a predetermined ratio, and wherein in particular for each feeding place an associated recipe is stored in the memory, wherein the control system is configured to:
   at a first moment, determine a feed requirement for the feeding places on the basis of a feeding criterion and the feed quantity measured by the feed quantity measuring device at the feeding places, and to determine, for at least each feeding place with a feed requirement, in particular a feed requirement greater than 0, the associated recipe for mixed feed, for example by retrieving the associated recipe from the memory,
   select a first feeding place from the feeding places with a feed requirement, and determine an associated first recipe, for example by retrieving said first recipe from the memory, i.e. the recipe belonging to the first feeding place is the first recipe,
   calculate the quantity of feed to be loaded, in particular containing different ingredients according to the first recipe, which is equal to a sum of
      a required feed quantity according to the first recipe which is equal to
         a first feed quantity according to the first recipe which is determined for the first feeding place, and
         one or more further feed quantities according to the first recipe which are determined for one or more further feeding places selected by the control system from the feeding places with a feed requirement for mixed feed according to said first recipe, if said one or more further feed quantities according to said first recipe can be added to, i.e. totaled with, the first feed quantity according to the first recipe without exceeding the maximum feed load of the holder of the autonomous feeding device,
      wherein the control system is configured to compare the required feed quantity with a threshold value for a minimum feed load, and
      if the control system, on the basis of said comparison of the required feed quantity of feed with the threshold value for the minimum feed load, determines that the required feed quantity is smaller than the threshold value for the minimum feed load, one or more additional feed quantities according to the first recipe which are determined for one or more additional feeding places selected by the control system from the feeding places which do not yet have a feed requirement for mixed feed according to said first recipe at the first moment, but which will have a feed requirement for mixed feed according to said first recipe after the first moment, in particular feeding places for which the first recipe is stored in the memory, wherein the control system determines the one or more additional feeding places such that the quantity of feed to be loaded is equal to or greater than the threshold value for the minimum feed load,
   control the feed loading system to load the calculated quantity of feed to be loaded, in particular containing the ingredients according to the first recipe, from the feed supply into the holder of the feeding device, and
   control the feeding device to bring the loaded quantity of feed according to the first recipe to the one or more selected feeding places, i.e. the first feeding place, where applicable the one or more further feeding places with a feed requirement for mixed feed according to the first recipe, and in some cases the one or more additional feeding places which at the first moment do not yet have a feed requirement yet for mixed feed according to said first recipe but which after the first moment will have this, and dispense it there.

The first quantity of feed according to the first recipe, the one or more further quantities of feed according to the first recipe, and the one or more additional quantities of feed according to the first recipe contain the ingredients according to the first recipe. When feeding with mixed feed according to a prescribed recipe, i.e. with ingredients in a predetermined ratio, it is particularly important that the mixed feed actually dispensed corresponds precisely to the prescribed recipe. Because the feeding system according to the invention avoids feeding runs with small batches of feed, the quantities (kg) of the different ingredients according to the prescribed recipe can be loaded more precisely, and the differences between the prescribed recipe and the mixed feed actually dispensed are minimal. This is particularly favourable for the health of the animals, the milk or meat production, and the management of the feed supplies.

It is possible to avoid feeding runs with small batches of feed in various ways. According to the invention, it is possible (option 1) that the control system is configured to control the feed loading system—although the one or more additional feeding places at the first moment have no feed requirement yet on the basis of the feeding criterion, for example directly after that first moment—to already begin loading the calculated quantity of feed to be loaded from the feed supply into the holder of the feeding device, and then to control the feeding device to bring the loaded quantity of feed to the one or more selected feeding places and dispense it there, in particular irrespective of whether or not the additional feeding places have achieved a feed requirement after the first moment. In this case, the feeding system dispenses fresh feed as quickly as possible at the first feeding place, and where applicable at the one or more further feeding places which already have a feed requirement. The one or more additional feeding places are supplied even though said feeding places have no feed requirement. In other words, said additional feeding places are given feed early, which indeed means a loss of freshness, but has the advantages that the holder of the feeding device transports more feed, so that the capacity of the feeding system is improved, and when feeding with mixed feed, can be loaded more precisely according to the prescribed recipe, which is important for the health and productivity of the animals.

According to the invention, it is also possible (option 2) that the control system is configured to wait, after the first moment, until the one or more additional feeding places have achieved a feed requirement on the basis of the feeding criterion, and only then to control the feed loading system to begin loading the calculated quantity of feed to be loaded from the feed supply into the holder of the feeding device, and then to control the feeding device to bring the loaded quantity of feed to the one or more selected feeding places and dispense it there. In this case, the feeding device does not yet, at the first moment and directly afterwards, deliver feed to the first feeding place and where applicable the one or more further feeding places, even though these have a feed requirement. At said feeding places, for a short time too little feed or no feed will remain available, but this risk is acceptable to avoid the feeding device transporting batches of feed which are too small, and when feeding mixed feed, it can be loaded more precisely according to the prescribed recipe.

According to the invention, it is furthermore possible to combine the above-described options 1 and 2. In particular, the control system of the feeding system according to the invention may be configured to carry out option 1 first, but if for example on the basis of a second less stringent feeding criterion still too few additional feeding places would be selected to fill the holder of the feeding device above the minimum feed load, the control system can then carry out option 2.

In one embodiment according to the invention, for each feeding place, a value for a quantity of feed to be dispensed is stored in the control system. In other words, the control system contains a memory in which, for each feeding place, a value is stored and/or established which is representative of the quantity of feed to be dispensed when said feeding place has a feed requirement, for example a value in kg. Said value for each individual feeding place may for example be entered manually by a user, in particular depending on the group of animals to be fed at the feeding place. When a feeding place has a feed requirement, according to the invention, the control system therefore uses said values when calculating the quantity of food to be loaded.

In particular, when calculating the quantity of feed to be loaded, the control system sets the first feed quantity for the first feeding place, the one or more further feed quantities for the further feeding places, and the one or more additional feed quantities for the additional feeding places equal to the values established in the memory for the quantity of feed to be dispensed for said feeding places. It is however also possible that the control system is configured to check the values entered manually by the user for each feeding place and if necessary adapt these on the basis of data available for said feeding place in the memory of the control system, such as the dimensions of the feeding place, the number of animals fed at the feeding place, and the required feed value of said animals, for example depending on the lactation phase when feeding dairy cows. In addition, the control system may be configured to calculate the feed quantity for each feeding place on the basis of the feed requirement of said feeding place. In this case for example, there is no manual input by the user, but the control system automatically determines the feed quantities to be dispensed, in particular on the basis of the feed requirement.

In one embodiment according to the invention, the threshold value for the minimum feed load can be set. In particular, the threshold value for the minimum feed load can be entered by a user in the control system. The user can for example set the threshold value for the minimum load at “0”, i.e. if required, the user can then exclude the occurrence of feeding runs with small batches. If the value is set at “0”, the above-described required feed quantity still cannot be smaller than the threshold value for the minimum feed load, and the control system does not add one or more additional feed quantities to the feeding run. According to the invention, it is also possible that the threshold value for the minimum load can be set automatically by the control system, for example depending on the maximum feed load. Also according to the invention, with mixed feed it is possible that the threshold value for the minimum feed load is dependent on the recipe.

If the feeding system according to the invention is used for feeding with mixed feed, the maximum feed load may be dependent on the first recipe belonging to the selected first feeding place. In this case, it is possible that for each recipe, an associated maximum feed load is entered by the user in the memory of the control system. The control system is configured to determine, in particular retrieve from the memory, the maximum feed load of the holder during operation, after the first feeding place has been selected and the associated first recipe determined. Moreover, it may also be possible to set the maximum feed load when feeding with only one feed type, e.g. when switching to another feed type or if the composition of the feed type changes over time.

The control system can determine in various ways whether the feeding places have a feed requirement greater than 0.

In one embodiment of the invention, the feeding criterion comprises a threshold value for the quantity of available feed at the feeding places, wherein the control system is configured to determine the feed requirement of the feeding places by comparing the feed quantity measured by the feed quantity measuring device at the feeding places with said threshold value for the quantity of available feed. For each feeding place, the control system determines whether the measured feed quantity at said feeding place has fallen below the threshold value for the quantity of available feed. If that is the case, the feeding place has a feed requirement, in particular a feed requirement greater than 0. As described above, fixed values may be set in the control system for the quantity of feed to be dispensed for each individual feeding place. It is however also possible that the control system determines how much feed should be dispensed for each individual feeding place on the basis of the difference between the measured feed quantity and the threshold value for the quantity of available feed.

Preferably, the threshold value for the quantity of available feed is set such that the feeding device dispenses feed at each feeding place before the animals have consumed the feed at said feeding place. The feeding criterion is such that feed is added in each case before the feed runs out at one of the feeding places. In other words, the feeding system according to the invention normally guarantees that feed is available at the feeding places and the animals can almost always eat.

In an alternative embodiment for determining the feed requirement, the control system is configured to store in a memory the feed quantities measured by the feed quantity measuring device at the feeding places at different moments, as feed quantity values, and on the basis of said stored feed quantity values, calculate i.e. predict, in particular by means of a self-learning algorithm, the development of the feed quantity values over time after the first moment, wherein the control system is configured to use the calculated development when determining the feed requirement of the feeding places at the first moment. By determining for example when the feed runs out at the feeding places and then calculating back how much time is required to prepare the feed in the holder of the feeding device and/or a stationary (pre)mixer, and how long it takes to bring the feed loaded into the holder to the feeding places, the control system can also in this way determine a feed requirement of the feeding places.

In this case too, it is preferred that the animals can always eat. The control system is in particular configured to determine a feed requirement of the feeding places on the basis of the calculated development, such that the feeding system dispenses feed to each feeding place before the animals have consumed the feed at said feeding place.

In one embodiment, the control system is configured to determine which feeding place with a feed requirement has the highest priority, for example by determining at which feeding place the feed quantity measured by the feed quantity measuring device has fallen furthest below the threshold value for the quantity of available feed, or to determine at which feeding place the feed is predicted to run out first. The control system can then select said feeding place as the first feeding place. The first feeding place in this case is the feeding place with the highest priority for additional feed, in particular the feeding place with the greatest difference between the measured remaining feed quantity and the threshold value, or the feeding place for which it is predicted that the feed at said feeding place will run out first. The feeding system according to the invention takes said feeding place as the starting point for the next following feeding run. The feeding place which must be filled up with fresh feed first receives additional feed in the next feeding round of the autonomous feeding device. Thus the risk is minimal that one or more of the feeding places will become empty, or in any case an empty feeding place is filled up with feed as soon as possible, so that the animals can substantially always eat. The word “empty” must be understood to mean that the feeding places are effectively empty, i.e. if a residual feed quantity remains which is substantially no longer suitable for consumption by the animals or in practice cannot be consumed by the animals, the feeding place is “empty”. The feed has then “run out” even if a small feed quantity remains.

In a particular embodiment, the control system is configured-as described above—to first determine which feeding place with a feed requirement has the highest priority. Then the control system does not simply select the feeding place with the highest priority as the first feeding place, but the control system first determines a feed quantity for said feeding place with the highest priority, for example by retrieving from the memory a quantity entered by the user for feed to be dispensed for said feeding place. The control system compares said feed quantity with the threshold value for a minimum feed load. If the feed quantity for the feeding place with the highest priority is greater than or equal to the threshold value for the minimum feed load, the control system selects the feeding place with the highest priority as the first feeding place. If the feed quantity for the feeding place with the highest priority is however smaller than the threshold value for the minimum feed load, the control system selects another feeding place with a feed requirement as the first feed place, if there is another feeding place with a feed requirement for which the quantity of feed to be dispensed is greater than the threshold value for the minimum feed load. In this case, the control system is programmed to check whether it is possible to first carry out a larger feeding run. If only small feeding runs are to be carried out, the control system according to the invention then adds additional feed quantities for additional feeding places which as yet have no feed requirement, as described above. This effectively excludes that the feeding system carries out feeding runs with small batches of feed.

The feed loading system according to the invention can be configured in various ways. For example, it is possible that the holder of the autonomous feeding device comprises a mixing device for mixing the quantity of feed loaded into the holder. The feed loading system can load feed from the feed supply, in particular different ingredients or feed types, into the holder of the autonomous feeding device, whereupon the mixing device of the autonomous feeding device mixes the feed loaded into the holder into a mixed batch of feed. The autonomous feeding device then brings the mixed batch of feed to the one or more feeding places. The autonomous feeding device in this case forms a mixing and feeding device. Also, the feed in the holder of the autonomous feeding device may already be prepared in some way, i.e. the batch of feed may be loaded in advance, before the autonomous feeding device begins to bring the feed to the one or more feeding places.

However, according to the invention, it is also possible that the feed loading system comprises a stationary mixing device for mixing feed. The stationary mixing device is for example configured to receive a feed quantity which corresponds to a batch of feed for the holder of the autonomous feeding device. In this case, the feed loading system is configured for loading feed from the feed supply into the stationary mixing device, and for loading the mixed feed from the stationary mixing device into the holder of the autonomous feeding device for receiving therein a mixed feed batch. Then the autonomous feeding device transports the mixed feed batch to the feeding places. In this case, the feeding device does not simultaneously form the mixing device—the feeding device is configured solely for dispensing the feed. Also in this case, the batch of feed, in some cases premixed in the stationary mixing device, may be made available before the mixed feed is loaded into the holder of the autonomous feeding device.

In addition, it is possible that the autonomous feeding device as described above comprises a mixing device, i.e. is configured as an autonomous mixing and feeding device, and a stationary mixer is also used for mixing and/or chopping the feed before the feed is transferred to the holder of the feeding device. The premixed and/or pre-cut feed is then ready more quickly for dispensing by the feeding device.

Moreover, the feeding places according to the invention may be configured in various ways. It is preferred that the or each feeding place has at least one feed fence for feeding the animals, such as in a shed, wherein the feeding device is configured for autonomously transporting a batch of feed received in the holder from the feed supply to the feed fence, and autonomously dispensing and/or delivering said feed along the feed fence. Here a single feed fence structure in the shed may correspond to several feed fences in the control system, i.e. if different, mutually separate groups of animals are kept in the shed along a single feed fence structure, in the control system each part of the feed fence structure belonging to a group of animals is defined as a feed fence. The feeding places or feed fences are each coupled to a group of animals.

The feed quantity measuring device may also be configured in various ways. In a preferred embodiment, the feed quantity measuring device is arranged on the feeding device, wherein the feed quantity measuring device is configured to measure the quantity of feed available for consumption by the animals at the or each feeding place when the feeding device moves along said feeding place. Preferably, the feeding device furthermore comprises a feed pusher device for pushing feed in a direction transversely to the movement direction or travel direction of the feeding device. For example, the feed pusher device is configured for pushing feed which lies along a feeding place, and has been displaced from the feeding place by the animals during eating, back to the feeding place.

According to the invention, it is furthermore possible that the holder of the autonomous feeding device comprises a dispensing device for dispensing feed from the holder. The feed quantity measuring device may thus be arranged on the autonomous feeding device relative to the dispensing device such that, when measuring the quantity of feed available for consumption by the animals at the feeding places, the feed quantity just dispensed by the dispensing device is included. In other words, the feed quantity dispensed by the autonomous feeding device is also included in the measurement of the quantity of feed present at the or each feeding place for consumption by the animals. In this case, the feed pusher device may be configured for pushing feed which has been dispensed by the autonomous feeding device. In other words, when the feed is dispensed from the holder of the autonomous feeding device, said feed is immediately pushed. Then the feed quantity measuring device measures the pushed feed, which includes both feed already present at the feeding place and freshly dispensed feed.

In an alternative embodiment, the feed quantity measuring device comprises for example one or more cameras which are configured to capture images of the feed at the feeding places, wherein the control system is configured to determine the quantity of feed available for consumption by the animals at the feeding places on the basis of the camera images, in particular by means of image recognition. In this case, it is possible that one or more of the cameras are arranged in a shed for keeping animals. Instead or in addition, the one or more cameras may be arranged on the autonomous feeding device. By means of camera images and image recognition techniques, it is also possible to measure precisely the quantity of feed at the feeding places.

The feeding device of the feeding system according to the invention may also be configured in various ways. Preferably, the autonomous feeding device is a self-propelled carriage with wheels. The feed carriage can then travel via the wheels over a floor, farmyard or other ground. Thus the feeding system according to the invention can be used relatively easily and cost-effectively in farms. The autonomous feeding device may however also be suspended on a rail along which the feeding device can move autonomously to the feeding places. In this case, adaptation of the farm with the rail entails extra costs. Evidently, according to the invention it is possible that the feeding system comprises more than one autonomous feeding device, in particular two autonomous feeding devices.

The invention also concerns, in combination, a shed for keeping animals, such as dairy cows or beef cattle, and a feeding system as described above.

The invention furthermore concerns a method for feeding animals, in particular cattle, such as dairy cows or beef cattle, at multiple feeding places with feed from a feed supply, using a feeding system as described above.

The method according to the invention has the same technical effects and advantages as described above with respect to the system according to the invention.

The invention will now be explained in more detail below with reference to the appended figures.

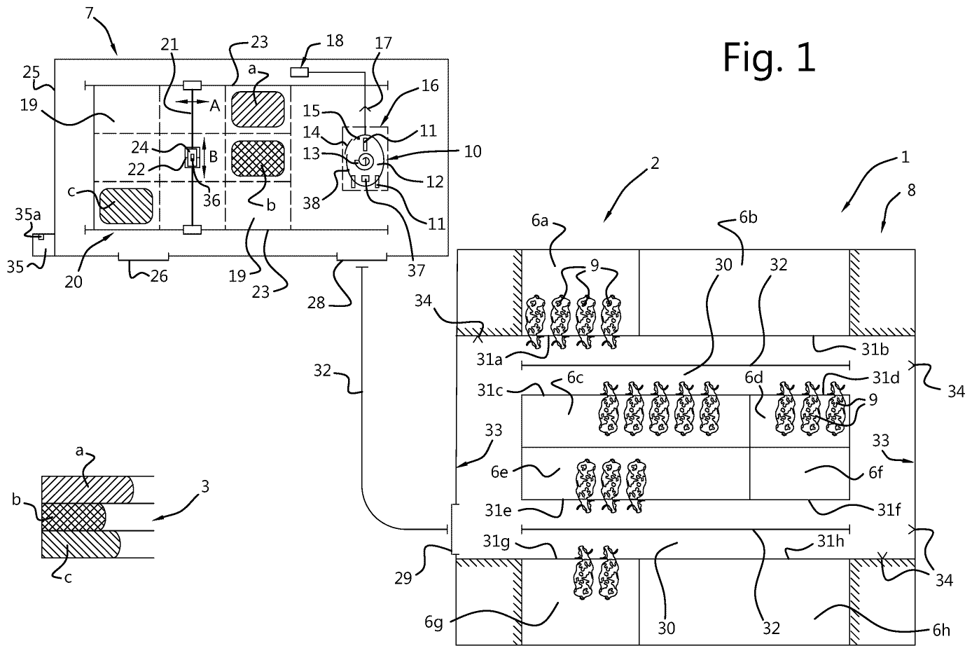

FIG. 1 shows a schematic top view of a feeding system according to the invention.

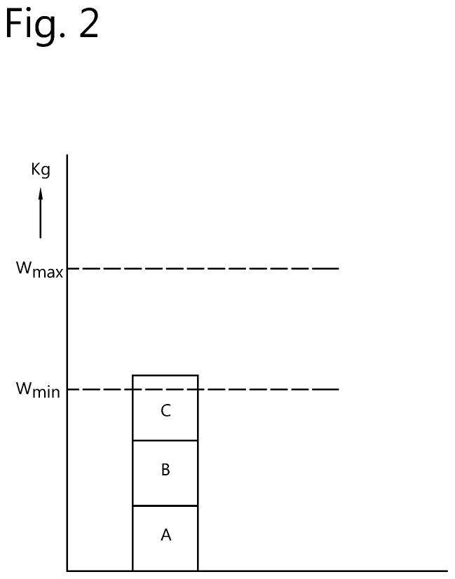

FIG. 2 Shows a Diagram Illustrating the Calculated Quantity of Feed to Be loaded.

The feeding system for feeding animals, in particular cattle, such as dairy cows or beef cattle, is indicated as a whole in FIG. 1 with reference sign 1. The feeding system 1 is arranged in an operating area 2. The feeding system 1 comprises a feed store 3 with multiple feed types a, b, c, a feed supply 7 with—in this exemplary embodiment—the same feed types a, b, c, a shed 8 with the animals 9, and an autonomous feeding device 10 for feeding the animals 9 with feed from the feed supply 7. Although the feed store 3 illustrated schematically in FIG. 1 comprises three adjacent silos with feed types a, b, c, for example silage, the feed store 3 may comprise further storage devices and/or feed types, such as tower silos with bulk feed, e.g. maize, potatoes and/or sugar beet, or compressed bales. In the same way, the feed supply 7 may also contain more than the three feed types a, b, c illustrated in FIG. 1, such as feed concentrate. Evidently, the operating area 2 may also contain a dwelling, one or more further sheds, barns and other buildings (not shown).

The autonomous feeding device 10 for feeding the animals 9 in this exemplary embodiment is configured as a self-propelled feed carriage. Evidently, according to the invention, it is possible that the feeding system 1 comprises more than one autonomous feed carriage 10, in particular two autonomous feed carriages 10 (not shown). The feed carriage 10 can travel via wheels 11 over a floor, farmyard or other ground. The feed carriage 10 comprises a holder 12 for receiving a batch of feed. In this exemplary embodiment, a mixing device 13 for chopping and/or mixing feed is arranged in the holder 12. A dispensing device 14 is provided for dispensing and/or delivering feed from the holder 12. The dispensing device 14 comprises for example a door which is movable between a closed and an open state.

The feed carriage 10 can travel autonomously by means of a driving and steering system (not shown) for driving and steering the feed carriage 10. The driving and steering system of the feed carriage 10 is controllable by a control unit 15 of the feed carriage 10. In this exemplary embodiment, the driving and steering system comprises an electric drive motor (not shown) for each rear wheel 11. The electric drive motors of the rear wheels 11 are controllable independently of one another. By controlling the rotation speed of the rear wheels 11, the feed carriage 10 can travel straight forwards, straight backwards or round corners.

The driving and steering system comprises a battery system (not shown) for storing electrical energy. The battery system is connected to the electric drive motors. In FIG. 1, the feed carriage 10 is positioned at a feed loading station 16, where the holder 12 of the feed carriage 10 is loaded with feed. The feed loading station 16 comprises a charging point 17 of a charging system 18 for charging the battery system of the feed carriage 10. The feed loading station 16 therefore also forms a charging station. The control unit 15 of the feed carriage 10 is configured to control the mixing device 13 such that the mixing device 13 mixes the feed received in the holder 12 while the feed carriage 10 is connected to the charging point 17 and the battery system of the feed carriage 10 is being charged by means of the charging system 18.

The feed supply 7 in this exemplary embodiment forms a feed kitchen, i.e. a temporary feed store. The feed kitchen comprises a number of feed supply stations 19 containing the feed types a, b, c and where applicable other feed types (not shown). The feed supply stations 19 are arranged separately from one another—the feed supply stations 19 are for example formed by marked areas on a floor, on which a block of silage or a compressed bale is received. Also, one or more of the feed supply stations 19 may comprise a trough for receiving bulk feed, such as maize, potatoes or sugar beet. The capacity of the feed kitchen 7 is limited for example to a few days. The feed quantities of the feed types a, b, c which can be received in the feed kitchen 7 are smaller than the feed quantities of the feed types a, b, c which are stored in the feed store 3.

A feed loading system 20 is provided for transferring feed from the feed kitchen 7 to the holder 12 of the feed carriage 10 when the feed carriage 10 is positioned at the feed loading station 16. In this exemplary embodiment, the feed loading system 20 comprises a mobile carrying rail 21 which is movable (see arrow A) on two fixed carrying rails 23 which are mutually parallel and spaced apart from one another. The mobile carrying rail 21 comprises a trolley 22 which is movable thereon (see arrow B). The trolley 22 is provided with a vertically movable feed gripper 24 for gripping feed from the feed supply stations 19. The feed gripper 24 suspended on the trolley 22 is driveable via a motor 36 and can move in a largely horizontal plane to above each of the feed supply stations 19.

The feeding system 1 according to the invention comprises a control system 35 with a memory 35a. Although the control system 35 is drawn schematically on the left in FIG. 1, the control system 35 may also be arranged at another location. The memory 35a may comprise a memory on a farm computer, a server of the manufacturer of the feeding system 1 which is connected via the internet to the control system 35, and/or a cloud memory and/or others.

The feed gripper 24 is controlled by the control system 35. Recipe data are stored in the memory 35a. The recipe data comprise for example several recipes for different groups of animals 9. A recipe is a ration. On the basis of the recipe data of a selected recipe, i.e. mixed feed of ingredients or feed types in a desired ratio (kg), the feed gripper 24, while the feed carriage 10 is positioned at the feed loading station 16, brings quantities of the feed types a, b, c from the feed supply stations 19 to the holder 12 of the feed carriage 10, so that the recipe selected is received in the holder 10. By transferring several feed types to the holder 12 of the feed carriage 10, a batch of mixed feed is created therein with feed types according to the selected recipe and in a desired quantity which is dependent on the feed requirements, i.e. a batch of mixed feed (kg) of ingredients or feed types in a desired ratio.

In other words, to compose the feed batch, the feed gripper 24 each time takes a feed quantity from one of the feed supply stations 19, the feed gripper 24 moves said feed over the feed supply stations 19 to above the holder 12 of the feed carriage 10, and allows said feed to fall into the container 12. The feed carriage 10 comprises a weighing device 37 which is configured to measure the weight (kg) of feed received in the holder 12. The weighing device 37 is connected to the control system 35. During loading of a feed batch into the holder 12 of the feed carriage 10, the control system 35 records how much feed (kg) of each feed type a, b, c is loaded into the holder 12.

Evidently, the feed supply 7 and the feed loading system 20 may also be configured differently. The feed gripper 24 may for example also be integrated with the feed carriage 10. In this case, the feed gripper of the feed carriage 10 loads the holder 12 with feed in the desired quantity and composition, in particular directly from the feed store 3. Furthermore, instead of or in addition to the feed supply stations 19 shown in FIG. 1, the feeding system 1 may comprise one or more other feed supply devices, such as a driven conveyor belt for receiving compressed bales or blocks cut from a silo, in combination with a separating device for releasing feed from such a bale or block, for example a cutter or knife, in particular a so-called “bale shredder”, and/or a trough for bulk feed with an auger for the metered delivery of the feed, such as a so-called “commodity box”, and/or a tower silo and/or others. Here, the feed loading system may be provided with one or more driven conveyor belts for moving the feed from the or each feed supply device into the holder 12 of the feed carriage 10.

In addition, it is possible that the feed is not mixed and/or chopped in the holder 12 of the feed carriage 10, but in a stationary mixer (not shown) which is erected close to the feed supply 7. In this case, the feed gripper 24 and/or other feed supply device loads a batch of feed from the feed supply system 7 into the stationary mixer. After mixing and/or chopping by means of the stationary mixer, the mixed feed is then loaded into the feed carriage 10. No mixing device need then be arranged in the holder 12 of the feed carriage 10. Moreover, it is also possible that the feed is premixed and pre-cut in a stationary mixer, and the feed carriage 10 nonetheless has a mixing device for further mixing and chopping of the feed.

When a stationary mixer is used, it is possible that the stationary mixer in each case receives a feed quantity which corresponds to a single batch of feed for the holder 12 of the feed carriage 10. The stationary mixer may however also have a capacity for receiving and preparing multiple batches of feed for the holder 12 of the feed carriage 10. The feed quantity in the stationary mixer then forms a premixed feed quantity which is supplied in portions to the holder 12 of the feed carriage 10, i.e. for several feeding rounds.

The feed kitchen 7 is surrounded by a safety fence 25. An access door 26 is arranged in the safety fence 25, so that for example a forklift truck or tractor can enter the feed kitchen 7 through the access door 27 in order to top up the feed supply stations 19 with the different feed types a, b, c from the feed store 3. In addition, the safety fence 25 contains an access door 28 for the feed carriage 10. The feed carriage 10 can travel into and out of the feed kitchen 7 via the access door 28. Evidently, it is possible that the safety fence 25 contains only one door through which both the feed carriage 10 and the tractor or forklift truck can travel into and out of the feed kitchen 7. Also, the safety fence 25 may run to the left of the feed loading station 16 and the access door 26 on FIG. 1, wherein the safety fence 25 isolates the feed kitchen 7 with the feed supply stations 19, but the feed loading station 16 remains freely accessible via the access door 26 (not shown).

The feeding system 1 may comprise, as well as the safety fence 25, further safety facilities, e.g. an emergency stop via which the feed carriage 10 and/or the feed loading system 20 is immediately stopped. Also for example, an alarm may be given and/or a message sent to a user, e.g. an e-mail or a text message to a smartphone.

The shed 8 contains a door opening 29 through which the feed carriage 10 can travel into and out of the shed 8. The door opening 29 is closeable by a shed door which can preferably be opened automatically. The shed 8 contains several mutually separate accommodation areas 6a-6h for keeping different groups of animals 9. The animals 9 are divided into groups depending for example on lactation phase and/or milk yield, such as in groups of high-yield and low-yield animals 9. Each group of animals 6 is fed with a quantity of feed according to a recipe which is matched to said animals 9. The recipe for some groups of animals 9 may be the same, and the recipe for one or more groups of animals 9 may also differ from the recipe for the other groups of animals 9.

The shed 8 in this exemplary embodiment has two feed aisles 30. Evidently, more or fewer feed aisles may be provided. In this exemplary embodiment, each feed aisle 30 is delimited on either side by several feed fences 31a-h. Each feed fence 31a-h delimits an accommodation area 6a-h for a group of animals 9. In other words, the shed 8 in this exemplary embodiment contains eight feed fences 31 a-h. Feed fences which lie in one another's extent and are formed in the shed 8 by a single fence structure, such as feed fences 31a and 31b, or feed fences 31e and 31f, are defined by software in the control system 35 as separate feed fences. The feed fences 31a-h each form a feeding place for feeding the animals 9 in the accommodation area 6a-h behind said feed fence. The animals 9 may stand next to one another along the feed fence 31a-h. The animals 9 stand with their heads towards the feed aisle 30 and can push their heads through the feed fence 31a-h to eat feed which has been deposited by the feed carriage 10 along the feed fence 31a-h.

The feed fences 31 a-h in the shed 8 lie at a distance from the feed loading station 16 of the feed kitchen 7. The feed carriage 10 can reach each feed fence 31a-h from the feed loading station 16. In the operating area 2, various beacons are arranged. In this exemplary embodiment, the beacons are formed by strips 32 arranged in or on a floor or other ground, walls 33 of the shed 8, and collision points 34. The feed carriage 10 comprises a sensor system (not shown) which is configured to cooperate with the beacons 32, 33, 34. The sensor system may furthermore for example comprise an ultrasound sensor or camera which is connected to the control unit 15 of the feed carriage 10, wherein the control unit 15 is configured to allow the feed carriage 10 to travel substantially parallel to and at a specific distance from the feed fence 31a-h. In addition, the feed carriage 10 in this exemplary embodiment comprises a gyroscope (not shown) for travelling straight ahead over a predefined distance. The gyroscope is connected to the control unit 15 of the feed carriage 10.

The memory 35a of the control system 35 contains not only the recipe data but also various other data, such as navigation data and operating data. The navigation data comprise beacon data of the beacons 32, 33, 34. On the basis of the navigation data, the feed carriage 10 is able to take different routes to and through the shed 8 from the feed loading station 16. The operating data comprise for example operating data for operating the dispensing device 14 of the feed carriage 10.

The feed carriage 10 comprises a feed quantity measuring device 38 for measuring the quantity of feed for consumption by the animals 9 and present along the feed fences 31a-h along which the feed carriage 10 travels. The feed quantity measuring device 38 comprises for example a laser which measures the feed height (h in mm) of the feed along the feed fences 31a-h. The feed quantity at each feed fence 31a-h can be calculated on the basis of the measured height h. In this exemplary embodiment, the feed quantity measuring device 38 is arranged on the feed carriage 10. The feed quantity measuring device 38 measures the feed height h while the feed carriage 10 travels along each feed fence 31a-h. Each time the feed carriage 10 travels along the feed fences 31a-h, the feed quantity measuring device 38 measures the associated feed heights h.

In this exemplary embodiment, the feed carriage 10 comprises a feed pusher device (not shown) for pushing feed in a direction transversely to the travel direction of the feed carriage 10, i.e. the feed pusher device pushes feed which lies along the feed fence 31a-h and has been displaced from the feed fence 31a-h by the animals 9 while eating, back to the feed fence 31a-h, so that a swathe-like heap of feed is created along the feed fence. When the feed carriage tops up the feed fence, the feed pusher device also moves the dispensed fresh feed. In other words, in this case after the dispensing device 14 has dispensed the fresh feed, the fresh feed is also pushed together with the feed which still lay along the feed fence 31a-h.

The feed quantity measuring device 38 is arranged on the feed carriage 10 such that when the feed carriage dispenses feed at a feed fence, the feed just deposited by the dispensing device 14 is included in the measurement of the feed quantity, i.e. the dispensing device 14 first dispenses the feed from the holder 12 in front of the feed fence 31 and, directly afterwards, the feed quantity measuring device 38 measures the feed height of the pushed heap of feed at said feed fence 31. The measured feed height depends on the quantity of feed which has not yet been consumed, i.e. was dispensed earlier, and on the quantity of freshly dispensed feed at said feed fence 31.

The control system 35 is configured for receiving the feed heights measured along the feed fences 31a-h. The feed heights are first stored temporarily in a memory of the control unit 15 of the feed carriage 10. After the feed carriage 10 has returned to the feed loading station 16, the measured feed heights are sent to the control system 35 and stored at least temporarily in the memory 35a of the control system 35. The control system 35 is programmed to calculate the quantity of feed available for consumption by the animals 9 at each feed fence 31a-h on the basis of the measured feed heights h.

The feed quantity measuring device may however also be configured differently. For example, the feed quantity measuring device may contain one or more cameras which take a camera image of the feed fences 31a-h. In this case, the control system 35 is configured to determine, on the basis of the camera images, the quantity of feed available for consumption by the animals 9 at the feeding places 31a-h. It is also possible that a feed trough with one or more weight sensors is arranged along each feed fence 31a-h. In this case, the weight sensors can measure the weight of the feed quantity at each feed fence 31a-h.

The feeding system 1 according to the invention works on a demand-led principle. The control system 35 uses a feeding criterion. In this exemplary embodiment, the feeding criterion comprises a threshold value for the quantity of feed available at the feed fences 31a-h. The threshold value can be set separately for each feed fence 31a-h. The control system 35 is configured to determine a feed requirement for each feed fence 31a-h by comparing the feed quantity measured by the feed quantity measuring device 38 for said feed fence 31a-h with the threshold value for the quantity of available feed.

In other words, for each feed fence 31a-h, the control system 35 determines whether the measured feed quantity at said feed fence 31a-h has fallen below the threshold value for the quantity of available feed. If that is the case, said feed fence 31a-h has a feed requirement, i.e. a feed requirement greater than 0.

The threshold values may for example be entered manually in the control system 35 by the farmer, or can be generated automatically by the control system 35. Preferably, the threshold values for the quantity of available feed are set such that the feed carriage 10 dispenses feed to each feed fence 31a-h before the animals 9 have consumed the feed. The feeding criterion is such that in each case, feed is added before the feed has run out at one of the feed fences 31a-h. In other words, the feeding system 1 according to the invention normally guarantees that feed is available at the feed fences 31a-h and the animals 9 can almost always eat.

The word “empty” must be understood to mean that the feed fences 31a-h are effectively empty, i.e. if a residual feed quantity remains which is substantially no longer suitable for consumption by the animals 9 or in practice will not be consumed by the animals 9, the feeding place is “empty”. The feed has then “run out” even if a small quantity of feed remains.

It is possible to determine the feed requirement in other ways. For example, the control system 35 may be configured to permanently store the feed heights measured by the feed quantity measuring device 38 at the feed fences 31a-h at different moments, as feed quantity values in the memory 35a of the control system 35. The control system 35 may be programmed, on the basis of these stored feed quantity values, to calculate i.e. to predict, in particular by means of a self-learning algorithm, the development of the feed quantity values over time. The control system 35 may then determine a feed requirement of the feed fences 31a-h by using the calculated development. By determining for example when the feed will run out at the feeding places and calculating back how much time is required to prepare the feed in the holder 12 of the feed carriage 10 and/or a stationary (pre)mixer, and how long it takes to bring the feed loaded into the holder 12 to the feed fences 31a-h, the control system 35 can also in this way determine which feed fences 31a-h have a feed requirement.

In this case too, it is preferred that the animals can always eat. In other words, in this case the control system 35 may be configured to determine the feed requirement of the feed fences 31a-h such that the feed carriage 10 dispenses feed at each feed fence 31a-h before the animals 9 have consumed the feed.

In this exemplary embodiment, on the basis of the measured feed quantity at the feed fences 31a-h and the feeding criterion, the control system 35 determines a feed requirement for each of the feed fences 31a-h. The feed requirement is dependent on time. The control system 35 generates a feed requirement list of feed fences which have a feed requirement at a first moment, i.e. a feed requirement greater than 0. The feed fences on the requirement list are considered for additional feed. In this exemplary embodiment, the control system 35 is furthermore configured to determine which feed fence 31a-h from the feed requirement list has the highest priority for additional feed, in particular by determining at which feed fence the feed quantity measured by the feed quantity measuring device 38 has fallen furthest below the threshold value for the quantity of available feed.

The control system 35 then determines an associated feed quantity for the feed fence with the highest priority. In this exemplary embodiment, for each feed fence 31a-h, a value for a quantity of feed to be dispensed is stored in the memory 35a of the control system 35, in particular a value in kg. Said value for each individual feed fence 31a-h is for example entered manually by the user. Therefore, a value (in kg) for the desired quantity of feed to be dispensed is added to each feed fence 31a-h. If a feed fence 31a-h has a feed requirement, the control system 35 retrieves the associated value for the quantity of feed to be dispensed.

The control system 35 then compares said feed quantity with a threshold value Wₘᵢₙ for a minimum feed load (see FIG. 2). The minimum feed load is a minimum weight of feed (kg) to be received in the holder 12. If the feed quantity for the feed fence with the highest priority is greater than or equal to the threshold value Wₘᵢₙ for the minimum feed load, the control system 35 selects said feed fence with the highest priority as the first feed fence and takes said feed fence as the starting point for the next feeding run.

If the quantity of feed for the feed fence with the highest priority is however smaller than the threshold value Wₘᵢₙ for the minimum feed load, the control system 35 selects another feed fence with a feed requirement as the first feed fence, if there is another feed fence with a feed requirement for which the quantity of feed to be dispensed is greater than the threshold value Wₘᵢₙ for the minimum feed load. The control system 35 then selects said other feed fence as the first feed fence for additional feed.

Let us assume that feed fence 31a has the highest priority and the associated value for the feed quantity to be dispensed at feed fence 31a is greater than the threshold value Wₘᵢₙ for the minimum feed load. The feeding system 1 selects said feed fence 31a as the first feed fence and takes said feed fence 31a as the starting point for the next following feeding run. Said feed fence 31a, which should be supplemented first with fresh feed, is topped up in the next feeding round of the feed carriage 10. If the associated value for the quantity of feed to be dispensed at the feed fence 31a with the highest priority is however smaller than the threshold value Wₘᵢₙ for the minimum feed load, the control system 35 first analyses whether there is another feed fence with a feed requirement and a lower priority, for which the associated value for the quantity of feed to be dispensed is greater than the threshold value Wₘᵢₙ for the minimum feed load. If this is the case, the control system 35 selects said other feed fence as a starting point for the next feeding run. But if there is no such feed fence on the feed requirement list, i.e. there are exclusively relatively small feeding runs, the control system selects the feed fence 31a with the highest priority.

After the control system 35 has selected the first feed fence 31a from the feed requirement list, the control system 35 calculates the quantity of feed for loading into the holder 12 of the feed carriage 10 in the following manner.

Firstly, the control system 35 determines a first quantity A of feed to be dispensed at said first feed fence 31a (see FIG. 2). The first feed quantity A is equal to the value stored in the memory 35a for the quantity of feed to be dispensed at said feed fence 31a. Then the control system 35 determines, on the basis of the values stored in the memory 35a for the desired quantities of feed to be dispensed (in kg), which further feed quantities are required at the further feed fences from the feed requirement list. The control system 35 analyses whether one or more of said further feed quantities can be added to the first feed quantity without exceeding a threshold value Wₘₐₓ for a maximum feed load of the holder 12. The maximum feed load is a maximum weight of feed (kg) which can be received in the holder 12. The control system 35 adds as many further feed quantities as possible to the first feed quantity.

Let us assume that the feed fences 31d and 31f have a feed requirement for the same mixed feed as the first feed fence 31a. The feed quantities required at the feed fences 31d and 31f may then be totaled to increase the batch of feed in the holder 12, provided that the maximum feed load Wₘₐₓ of the holder 12 is not exceeded. The total of further feed quantities, which correspond to the quantities of feed to be dispensed at the feed fences 31d and 31f, is indicated with B in FIG. 2.

Therefore the control system 35 calculates a required feed quantity which is equal to the sum of the first feed quantity A and the one or more further feed quantities (jointly B). If there is no single further feed quantity for the further feed fences from the feed requirement list which fits with the first feed quantity in the holder 12, the required feed quantity is equal to the first feed quantity A.

In practice, it occurs that the required feed quantity, i.e. even after all possible further feed quantities for the further feed fences from the feed requirement list have been added to the first feed quantity, is still undesirably small. This is shown in FIG. 2: the required feed quantity A+B is smaller than the threshold value Wₘᵢₙ for a minimum feed load.

The control system 35 is programmed according to the invention to avoid excessively small feed batches. The control system 35 compares the required feed quantity (A+B in FIG. 2) with the threshold value Wₘᵢₙ for the minimum feed load. If the comparison of the required feed quantity (A+B in FIG. 2) with the minimum feed load Wₘᵢₙ shows that the required feed quantity is smaller than the threshold value Wₘᵢₙ for the minimum feed load, the control system 35 increases the quantity of feed to be loaded.

The control system selects one or more additional feed fences 31a-h which have no feed requirement at the first moment, i.e. at the moment when the feed requirement list is generated, and adds one or more additional feed quantities which are intended for the one or more selected additional feed fences. The control system 35 determines the one or more additional feed fences 31a-h such that the feed quantity to be loaded is equal to or greater than the threshold value Wₘᵢₙ for the minimum feed load.

The control system 35 may be programmed, for the feed fences which are not on the feed requirement list, i.e. have no feed requirement at the first moment, to determine a second feed requirement on the basis of a second, less stringent feeding criterion. The control system then selects the one or more additional feed fences on the basis of said second feed requirement. In this exemplary embodiment, the control system 35 is configured to select the feed fence or the feed fences which have the highest priority on the basis of the second, less stringent feeding criterion. In other words, the control system 35 selects the feed fence or the feed fences which do not yet have a feed requirement on the basis of the original feeding criterion, but which are closest to this, as the additional feed fence or the additional feed fences.

Let us assume that the feed fence 31g is not on the feed requirement list, i.e. has no feed requirement yet, but in the future will have a feed requirement for the same mixed feed as the first feed fence 31a, and on the basis of the second, less stringent feeding criterion, feed fence 31g will then be the first to be considered for additional feed. The control system 35 then adds an additional feed quantity C, which is intended for the feed fence 31g, to the required feed quantity A+B, so that the total quantity of feed to be loaded into the holder 12 of the feed carriage 10 becomes greater than the threshold value Wₘᵢₙ for the minimum feed load (see FIG. 2). The control system 35 then also checks that the total feed quantity to be loaded, A+B+C, remains smaller than the threshold value Wₘₐₓ for the maximum feed load.

After the feed quantity to be loaded is calculated in this way, the control system 35 controls the feed loading system 20 to load the calculated feed quantity from the feed kitchen 7 into the holder 12 of the feed carriage 10. Then the feed carriage 10 brings the loaded feed quantity to the one or more selected feed fences, i.e. in this exemplary embodiment to the first feeding place 31a, the further feed fences 31d and 31f with a feed requirement, and the additional feed fence 31g which is not on the feed requirement list.

When feeding with mixed feed according to a prescribed recipe, i.e. with ingredients or feed types in a predetermined ratio, it is particularly important that the mixed feed actually dispensed corresponds precisely to the prescribed recipe. Because the feeding system 1 according to the invention avoids feeding runs with small feed batches, the quantities (kg) of the different ingredients or feed types can be loaded more precisely according to the prescribed recipe, and the differences between the prescribed recipe and the mixed feed actually dispensed are minimal. This is particularly favourable for the health of the animals, the milk or meat production, and the management of feed supplies.

Feeding runs with small batches of feed can be avoided in various ways according to the invention.

According to a first option, it is possible that, although the additional feed fence 31g at the first moment has no feed requirement yet, the control system 35 is configured to control the feed loading system 20 already, for example directly after the first moment, to begin loading the calculated quantity of feed to be loaded from the feed kitchen 7 into the holder 12 of the feed carriage 10, and then to control the feed carriage 10 to bring the loaded feed quantity to the feed fences 31a, 31d, 31f, 31g and dispense it there, irrespective of whether the additional feed fence 31g has achieved a feed requirement after the first moment.

In this case, the feeding system 1 delivers fresh feed as quickly as possible to the feed fences 31a, 31d, 31f, 31g. The additional feed fence 31g is then already topped up, although said feed fence 31g as yet has no feed requirement. In other words, the additional feed fence 31g receives feed early, which in some way reduces the freshness, but has the advantage that the holder 12 of the feed carriage 10 can be loaded more precisely.

As an alternative (option 2), the control system 35 may be programmed to wait, after the first moment, until the additional feed fence 31g has achieved a feed requirement on the basis of the feeding criterion, and only then control the feed loading system 20 to begin loading the calculated quantity of feed to be loaded from the feed kitchen 7 into the holder 12 of the feed carriage 10, and then control the feed carriage 10 to bring the loaded feed quantity to the feed fences 31a, 31d, 31f, 31g and dispense it there.

In this case, the feed carriage 10 does not bring feed to the first feed fence 31a or the further feed fences 31d and 31f at the first moment, although these already have a feed requirement. For a short time, there may be too little or no feed at all available at said feed fences 31a, 31d, 31f, but this risk is acceptable to avoid the feed carriage 10 delivering excessively small feed batches, and to be able to load more precisely according to the prescribed recipe.

It is possible to combine the above-described options 1 and 2. For example, the control system 35 may be programmed to first carry out option 1, but if for example on the basis of the second, less stringent feeding criterion, still too few additional feed fences can be selected to be able to fill the holder 12 of the feed carriage 10 above the minimum feed load, the control system 35 can then carry out option 2.

The above-described feeding system 1 has the advantages of demand-led feeding, i.e. it is guaranteed that the animals 9 always have sufficient feed at their disposal, wherein the quality of the feed, in particular the freshness, is retained as far as possible, while furthermore avoiding the demand-controlled feed carriage 10 delivering small batches of feed, so that the capacity of the holder 12 is better used and the capacity of the demand-led feeding system 1 during the day is greater, and furthermore the feed can follow the prescribed recipe more precisely.

The invention is not restricted to the exemplary embodiment shown in the figures. The person skilled in the art may make various adaptations which lie within the scope of the invention. For example, the above-described feeding system is also suitable for dispensing mixed feed according to the same recipe at all feed fences 31a-h. In addition, the feeding system may provide different unmixed feed types to different feed fences, for example silage to a first group of feed fences and maize to another group of feed fences.

1. A feeding system for feeding animals, multiple feeding places with feed from a feed supply, wherein the feeding-system comprises:
at least one feeding device with holder for receiving a batch of feed, which holder has a maximum feed load, and which feeding device is configured to move autonomously to the feeding places in order to bring feed received in the holder to the feeding places and dispense it there,
a feed loading system for loading feed from the feed supply into the holder of the feeding device,
a feed quantity measuring device for repeated measurement of the quantity of feed available for consumption by the animals at the feeding places, and
a control system configured to:
at a first moment, determine a feed requirement for the feeding places on the basis of a feeding criterion and the feed quantity measured by the feed quantity measuring device at the feeding places,
select a first feeding place from the feeding places with a feed requirement,
calculate the quantity of feed to be loaded which is equal to a sum of
a required feed quantity which is equal to
a first feed quantity which is determined for the first feeding place, and
one or more further feed quantities which are determined for one or more further feeding places selected by the control system from the feeding places with a feed requirement, if said one or more further feed quantities can be added to the first feed quantity without exceeding the maximum feed load of the holder of the autonomous feeding device,
wherein the control system is configured to compare the required feed quantity with a threshold value for a minimum feed load, and
if the control-system system, on the basis of said comparison, determines that the required feed quantity is smaller than the threshold value for the minimum feed load, one or more additional feed quantities which are determined for one or more additional feeding places selected by the control system from the feeding places which do not yet have a feed requirement at the first moment, in particular which will have a feed requirement after the first moment, wherein the control-system system determines the one or more additional feeding places such that the quantity of feed to be loaded is equal to or greater than the threshold value for the minimum feed load,
control the feed loading system to load the calculated quantity of feed to be loaded from the feed supply into the holder of the feeding device, and
control the feeding device to bring the loaded quantity of feed to the one or more selected feeding places and dispense it there.

2. The feeding system according to claim 1, wherein the control system is configured to determine, at least for the feeding places which at the first moment have no feed requirement on the basis of the feeding criterion, a second feed requirement on the basis of a second less stringent feeding criterion and the feed quantity measured by the feed quantity measuring device for the feeding places, and
wherein the control system is configured to select the one or more additional feeding places on the basis of said second feed requirement.

3. The feeding system according to claim 1, wherein the control system comprises a memory in which different recipes for mixed feed are stored,
wherein each recipe contains one or more ingredients in a predetermined ratio, and
wherein the control system is configured, for at least each feeding place with a feed requirement, to determine the associated recipe for mixed feed, wherein the recipe belonging to the first feeding place is a first recipe, and wherein the quantity of feed to be loaded is equal to a sum of
a required feed quantity according to the first recipe which is equal to
a first feed quantity according to the first recipe which is determined for the first feeding place, and
one or more further feed quantities according to the first recipe which are determined for one or more further feeding places selected by the control system from the feeding places with a feed requirement for mixed feed according to said first recipe, if said one or more further feed quantities can be added to the first feed quantity without exceeding the maximum feed load of the holder of the autonomous feeding device, and
if the control system, on the basis of a comparison of the required feed quantity with the threshold value for the minimum feed load, determines that said required feed quantity is smaller than the threshold value for the minimum feed load, one or more additional quantities of feed according to the first recipe which are determined for one or more additional feeding places selected by the control system from the feeding places which do not yet have a feed requirement for mixed feed according to said first recipe at the first moment, but after the first moment will have a feed requirement for mixed feed according to said first recipe, wherein the control system determines the one or more additional feeding places such that the quantity of feed to be loaded is equal to or greater than the threshold value for the minimum feed load.

4. The feeding system according to claim 1, wherein the control system is configured to control the feed loading system, including the one or more additional feeding places at the first moment have no feed requirement on the basis of the feeding criterion, to already begin loading the calculated quantity of feed to be loaded from the feed supply into the holder of the feeding device, and then to control the feeding device to bring the loaded quantity of feed to the one or more selected feeding places and dispense it there.

5. The feeding system according to claim 1, wherein the control system is configured to wait, after the first moment, until the one or more additional feeding places have achieved a feed requirement on the basis of the feeding criterion, and only then to control the feed loading system to begin loading the calculated quantity of feed to be loaded from the feed supply into the holder of the feeding device, and then to control the feeding device to bring the loaded quantity of feed to the one or more selected feeding places and dispense it there.

6. The feeding system according to claim 1, wherein for each feeding place a value for a quantity of feed to be dispensed is stored in the control system, including can be entered by a user into the control system, and
wherein the control system is configured, when calculating the quantity of feed to be loaded, to determine the first feed quantity for the first feeding place, the one or more further feed quantities for the one or more further feeding places, and the one or more additional feed quantities for the one or more additional feeding places, on the basis of said stored values.

7. The feeding system according to claim 1, wherein the threshold value for the minimum feed load and/or the maximum feed load of the holder can be set, including entered by a user in the control system.

8. The feeding system according to claim 1, wherein the feeding criterion comprises a threshold value for the quantity of available feed at the feeding places, and
wherein the control system is configured to determine the feed requirement of the feeding places by comparing the feed quantity measured by the feed quantity measuring device at the feeding places with said threshold value for the quantity of available feed, wherein in particular said threshold value for the quantity of available feed is set such that the feeding device dispenses feed at each feeding place before the animals have consumed the feed at said feeding place.

9. The feeding system according to claim 1, wherein the control system is configured to determine which feeding place with a feed requirement has the highest priority, and to select said feeding place as the first feeding place

10. The feeding system according to claim 1, wherein the control system is configured to:
determine which feeding place with a feed requirement has the highest priority,
determine a feed quantity for said feeding place with the highest priority,
compare said feed quantity for the feeding place with the highest priority with the threshold value for a minimum feed load,
if the feed quantity for the feeding place with the highest priority is greater than the threshold value for the minimum feed load, select the feeding place with the highest priority as the first feeding place, and
if the feed quantity for the feeding place with the highest priority is smaller than the threshold value for the minimum feed load, select another feeding place with a feed requirement as the first feeding place if, for said other feeding place, a feed quantity is determined which is greater than the threshold value for the minimum feed load.

11. The feeding system according to claim 1, wherein the holder of the feeding device comprises a mixing device for mixing the quantity of feed loaded into the holder.

12. The feeding system according to claim 1, wherein the feed quantity measuring device is arranged on the feeding device, and
wherein the feed quantity measuring device is configured to measure the quantity of feed available for consumption by the animals at the feeding places when the feeding device moves along said feeding places.

13. The feeding system according to claim 1, wherein the autonomous feeding device is a self-propelled carriage with wheels.

14. The feeding system according to claim 1, wherein the animals included dairy cows or beef cattle kept in a shed.

15. A method for feeding animals at multiple feeding places with feed from a feed supply, using a feeding system according to claim 1.

16. The feeding system according to claim 2, wherein the control system comprises a memory in which different recipes for mixed feed are stored,
wherein each recipe contains one or more ingredients in a predetermined ratio, and
wherein the control system is configured, for at least each feeding place with a feed requirement, to determine the associated recipe for mixed feed, wherein the recipe belonging to the first feeding place is a first recipe, and wherein the quantity of feed to be loaded is equal to a sum of
a required feed quantity according to the first recipe which is equal to
a first feed quantity according to the first recipe which is determined for the first feeding place, and
one or more further feed quantities according to the first recipe which are determined for one or more further feeding places selected by the control system from the feeding places with a feed requirement for mixed feed according to said first recipe, if said one or more further feed quantities can be added to the first feed quantity without exceeding the maximum feed load of the holder of the autonomous feeding device, and
if the control system, on the basis of a comparison of the required feed quantity with the threshold value for the minimum feed load, determines that said required feed quantity is smaller than the threshold value for the minimum feed load, one or more additional quantities of feed according to the first recipe which are determined for one or more additional feeding places selected by the control system from the feeding places which do not yet have a feed requirement for mixed feed according to said first recipe at the first moment, but after the first moment will have a feed requirement for mixed feed according to said first recipe, wherein the control system determines the one or more additional feeding places such that the quantity of feed to be loaded is equal to or greater than the threshold value for the minimum feed load.

17. The feeding system according to claim 2, wherein the control system is configured to control the feed loading system, including the one or more additional feeding places at the first moment have no feed requirement on the basis of the feeding criterion, to already begin loading the calculated quantity of feed to be loaded from the feed supply into the holder of the feeding device, and then to control the feeding device to bring the loaded quantity of feed to the one or more selected feeding places and dispense it there.

18. The feeding system according to claim 3, wherein the control system is configured to control the feed loading system, including the one or more additional feeding places at the first moment have no feed requirement on the basis of the feeding criterion, to already begin loading the calculated quantity of feed to be loaded from the feed supply into the holder of the feeding device, and then to control the feeding device to bring the loaded quantity of feed to the one or more selected feeding places and dispense it there.

19. The feeding system according to claim 2, wherein the control system is configured to wait, after the first moment, until the one or more additional feeding places have achieved a feed requirement on the basis of the feeding criterion, and only then to control the feed loading system to begin loading the calculated quantity of feed to be loaded from the feed supply into the holder of the feeding device, and then to control the feeding device to bring the loaded quantity of feed to the one or more selected feeding places and dispense it there.

20. The feeding system according to claim 3, wherein the control system is configured to wait, after the first moment, until the one or more additional feeding places have achieved a feed requirement on the basis of the feeding criterion, and only then to control the feed loading system to begin loading the calculated quantity of feed to be loaded from the feed supply into the holder of the feeding device, and then to control the feeding device to bring the loaded quantity of feed to the one or more selected feeding places and dispense it there.
